(19) United States
(12) Patent Application Publication
(10) Pub. No.: US 2026/0004572 A1
(43) Pub. Date: Jan. 1, 2026

(54) MODEL TRAINING METHOD, IMAGE PROCESSING METHOD, ELECTRONIC DEVICE AND STORAGE MEDIUM

(71) Applicant: Lemon Inc., Grand Cayman (KY)

(72) Inventors: Xiaojie JIN, Los Angeles, CA (US); Zhicheng HUANG, Beijing (CN); Jiashi FENG, Singapore (SG)

(21) Appl. No.: 18/879,621

(22) PCT Filed: Jun. 22, 2023
(86) PCT No.: PCT/SG2023/050440

§ 371 Date: Dec. 27, 2024

(30) Foreign Application Priority Data
Jun. 28, 2022 (CN) 202210754292.2

(51) Int. Cl. G06V 10/82; G06V 10/74; G06V 10/80

(52) U.S. Cl. CPC G06V 10/82; G06V 10/761; G06V 10/80

(57) ABSTRACT

The present disclosure provides a model training method and apparatus, and an electronic device; and the method includes: acquiring a first sample image, which includes a first image block which is uncovered and an second image block which is covered; processing the first sample image through a first model, to obtain a first image feature corresponding to the first image block; reconstructing the second image block according to the first image feature, to obtain a first image, and determining a fusion prediction feature of the first image block and the second image block, according to the first image feature; acquiring a target image feature in a target image, the target image being an image after preprocessing of the first sample image; and updating a model parameter of the first model, according to the first image, the second image block, the fusion prediction feature and the target image feature.

### CROSS-REFERENCE TO RELATED APPLICATION

The present disclosure claims priority of the Chinese patent application entitled “Model Training Method and Apparatus, and Electronic Device” filed to the Chinese Patent Office on Jun. 28, 2022, with the Application No. 202210754292.2, the disclosure of which is incorporated herein by reference in its entirety.

### TECHNICAL FIELD

Embodiments of the present disclosure relate to a field of image processing technology, and more particularly, to a model training method and apparatus, and an electronic device.

### BACKGROUND

By self-supervised learning, a feature extractor may be learned from unlabeled data, and further a feature may be obtained through the feature extractor, without annotating a training sample, thereby reducing costs of model training.

At present, self-supervised learning of a model may be implemented through a comparative learning method. For example, the model may construct a graphics relationship between a current input image and of other image by comparing the current input image with other images, and obtain a feature extractor by learning the relationship. However, the model trained through the above-described method fails to learn an association relationship between respective regions inside the image, further resulting in a poor effect of model training.

### SUMMARY

The present disclosure provides a model training method, an image processing method, an apparatus, an electronic device, a storage medium, a computer program product, and a computer program, for solving the technical problem of a poor effect of model training in the prior art.

In a first aspect, an embodiment of the present disclosure provides a model training method, comprising:
acquiring a first sample image, wherein the first sample image comprises a first image block which is uncovered and a second image block, which is covered;
processing the first sample image through a first model, to obtain a first image feature corresponding to the first image block;
reconstructing the second image block according to the first image feature, to obtain a first image, and determining a fusion prediction feature of the first image block and the second image block, according to the first image feature;
acquiring a target image feature in a target image, wherein the target image is an image after preprocessing of the first sample image; and
updating a model parameter of the first model, according to the first image, the second image block, the fusion prediction feature and the target image feature.

In a second aspect, an embodiment of the present disclosure provides an image processing method, comprising:
processing a plurality of images through a first model, to obtain a plurality of image features corresponding to the plurality of images, wherein the first model is a model obtained through training of reconstructed image comparative learning combined with predicted feature comparative learning; optionally, the first model may be the first model described in the first aspect above; and
classifying the plurality of images, according to the plurality of image features.

In a third aspect, an embodiment of the present disclosure provides a model training apparatus, comprising a first acquiring module, a processing module, a reconstructing module, a determining module, a second acquiring module, and an updating module, wherein,
the first acquiring module is configured to acquire a first sample image, wherein the first sample image comprises a first image block which is uncovered and a second image block, which is covered;
the processing module is configured to process the first sample image through the first model, to obtain a first image feature corresponding to the first image block;
the reconstructing module is configured to reconstruct the second image block according to the first image feature, to obtain a first image;
the determining module is configured to determine a fusion prediction feature of the first image block and the second image block according to the first image feature;
the second acquiring module is configured to obtain a target image feature in a target image, wherein the target image is an image after preprocessing of the first sample image; and
the updating module is configured to update a model parameter of the first model, according to the first image, the second image block, the fusion prediction feature and the target image feature.

In a fourth aspect, an embodiment of the present disclosure provides an image processing apparatus, comprising a processing module and a classifying module, wherein,
the processing module is configured to process a plurality of images through a first model, to obtain a plurality of image features corresponding to the plurality of images, wherein; the first model being is a model obtained through training of reconstructed image comparative learning combined with predicted feature comparative learning; and
the classifying module is configured to classify the plurality of images according to the plurality of image features.

In a fifth aspect, an embodiment of the present disclosure provides an electronic device, comprising: a processor and a memory; wherein,
the memory stores computer execution instructions; and
the processor executes the computer execution instructions stored in the memory, so that the at least one processor executes the model training method of the first aspect above, or the image processing method of the second aspect above.

In a sixth aspect, an embodiment of the present disclosure provides a computer readable storage medium, having computer execution instructions stored therein, wherein, the processor, when upon executing the computer execution instructions, implements the model training method of the first aspect above, or the image processing method of the second aspect above.

In a seventh aspect, an embodiment of the present disclosure provides a computer program product, comprising a computer program, wherein, the computer program, when executed by a processor, implements the model training method of the first aspect above, or the image processing method of the second aspect above.

In an eighth aspect, an embodiment of the present disclosure provides a computer program, wherein, the computer program, when executed by a processor, implements the model training method of the first aspect above, or the image processing method of the second aspect above.

The present disclosure provides a model training method, an image processing method, an apparatus, an electronic device, a storage medium, a computer program product and a computer program; the electronic device acquires a first sample image; the first sample image includes a first image block which is uncovered and an second image block which is covered; the first sample image is processed through a first model to obtain a first image feature corresponding to the first image block; the second image block is reconstructed according to the first image feature, to obtain a first image; a fusion prediction feature of the first image block and the second image block is determined according to the first image feature; a target image feature is acquired in a target image; the target image is an image after preprocessing the first sample image; and a model parameter of the first model is updated according to the first image, the second image block, the fusion prediction feature, and the target image feature. According to the above-described method, the electronic device may acquire an association relationship between respective regions inside the first image of the sample through the first image obtained by reconstructing the second image block and the covered first image block, and may acquire an association relationship between images through the fusion prediction feature and the target image feature. Therefore, upon training the first model, the first model may not only learn the association relationship between the respective regions inside the image, but also learn the association relationship between the images, to further improve an effect of model training.

### BRIEF DESCRIPTION OF DRAWINGS

In order to clearly illustrate the technical solution of the embodiments of the present disclosure or in the prior art, the drawings that need to be used in description of the embodiments or the prior art will be briefly described in the following; it is obvious that the described drawings are only related to some embodiments of the present disclosure; based on the drawings, those ordinarily skilled in the art can acquire other drawings, without any inventive work.

FIG. 1 is a schematic diagram of an application scenario provided by an embodiment of the present disclosure;

FIG. 2 is a schematic flow chart of a model training method provided by an embodiment of the present disclosure;

FIG. 3 is a schematic diagram of a first sample image provided by an embodiment of the present disclosure;

FIG. 4 is a schematic diagram of a procedure of acquiring a target image provided by an embodiment of the present disclosure;

FIG. 5 is a schematic diagram of a procedure of acquiring a target image feature provided by an embodiment of the present disclosure;

FIG. 6 is a schematic flow chart of a method of updating a model parameter provided by an embodiment of the present disclosure;

FIG. 7 is a schematic diagram of a procedure of a model training method provided by an embodiment of the present disclosure;

FIG. 8 is a schematic flow chart of an image processing method provided by an embodiment of the present disclosure;

FIG. 9 is a structural schematic diagram of a model training apparatus provided by an embodiment of the present disclosure;

FIG. 10 is a structural schematic diagram of an image processing apparatus provided by an embodiment of the present disclosure; and

FIG. 11 is a structural schematic diagram of an electronic device provided by an embodiment of the present disclosure.

### DETAILED DESCRIPTION

Exemplary embodiments will be described in more detail herein, examples of which are shown in the accompanying drawings. When the description below refers to the accompanying drawings, unless otherwise indicated, same reference signs in different drawings identify same or similar elements. The implementations described in the following exemplary embodiments are not representative of all implementations consistent with the present disclosure. Rather, they are merely examples of apparatuses and methods consistent with some aspects of the present disclosure as detailed in the appended claims.

For ease of understanding, concepts involved in the embodiments of the present disclosure will be illustrated below.

Electronic device: a device having wireless transmission and reception functions. The electronic device may be deployed on land, including those mounted indoors or outdoors, handheld, wearable, or vehicle-mounted; or may also be deployed on water surface (e.g., ships, etc.). The electronic device may be a mobile phone, a pad, a computer having wireless transmission and reception functions, a virtual reality (VR) electronic device, an augmented reality (AR) electronic device, a wireless terminal in industrial control, a vehicle-mounted electronic device, a wireless terminal in self driving, a wireless electronic device in remote medical, a wireless electronic device in smart grid, a wireless electronic device in transportation safety, a electronic device in smart city, a wireless electronic device in smart home, and a wearable electronic device, etc. The electronic device involved in the embodiments of the present disclosure may also be referred to as a terminal, user equipment (UE), an access electronic device, a vehicle-mounted terminal, an industrial control terminal, a UE unit, a UE station, a mobile station, a mobile platform, a remote station, a remote electronic device, a mobile device, a UE electronic device, a wireless communication device, a UE agent or a UE apparatus, etc. The electronic device may also be fixed or mobile.

In the related technology, a large amount of labeled data cannot be acquired in most model training scenarios (e.g., in the field of medical image recognition), and labeled data requires manual annotation, which takes a long time. However, by self-supervised learning, a feature extractor may be learned from unlabeled image data, and further a feature of an image is extracted through the feature extractor, which may effectively reduce costs of model training. At present, self-supervised learning of a model may be implemented through a comparative learning method. For example, an input image and a transformed image of the image (e.g., obtained by changing brightness, size, color, etc. of the input image, but keeping shape unchanged) are taken as positive samples, and the input image and other image are taken as negative samples for self-supervised training, so that the model may learn an association relationship between images. However, there is also an association relationship between regions inside the image, buy the model obtained by using the above-described model training method fails to learn the association relationship between the respective regions inside the image, further resulting in a poor effect of model training.

In order to solve the technical problems in the related technology, an embodiment of the present disclosure provides a model training method, including: acquiring a first sample image, the first sample image including a first image block which is uncovered and an second image block which is covered; processing the first sample image through a first model to obtain a first image feature corresponding to the first image block; reconstructing the second image block according to the first image feature, to obtain a first image; determining a fusion prediction feature of the first image block and the second image block according to the first image feature; processing the first sample image by means of image enhancement, contrast improvement, etc., to obtain a target image; further acquiring a target image feature corresponding to a portion of image in the target image; obtaining a first loss function according to the first image and the second image block; obtaining a second loss function through the fusion prediction feature and the target image feature; and updating a model parameter of the first model through the first loss function and the second loss function. In this way, the first model may not only learn an association relationship between respective regions inside the image through the first image and the second image block, but also learn an association relationship between images through the fusion prediction feature and the target image feature, to further improve an effect of model training.

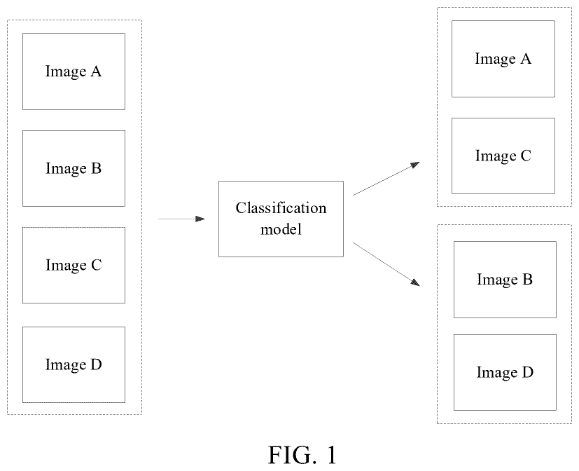

Hereinafter, application scenarios according to the embodiments of the present disclosure will be illustrated in conjunction with FIG. 1.

FIG. 1 is a schematic diagram of an application scenario provided by an embodiment of the present disclosure. Referring to FIG. 1, which includes an image A, an image B, an image C, an image D, and a classification model. For example, the first model according to the embodiment of the present disclosure (not shown in FIG. 1) is set up in the classification model. The image A, image B, image C and image D are input to the classification model; the classification model may acquire an image feature corresponding to each image, then classify the image A and image C into one class of images, and classify the image B and image D into one class of images according to the image features. In this way, because the first model in the classification model learns an association relationship between the images and an association relationship between regions inside an image, an effect of model training is better. Therefore, the classification model may accurately obtain an image feature corresponding to each image, to further improve accuracy of image classification. It should be noted that FIG. 1 is only an exemplary illustration of an application scenario according to the embodiment of the present disclosure, and is not a limitation on the application scenario.

Hereinafter, the technical solution of the present disclosure and how the technical solution of the present disclosure solves the above-described technical problems will be illustrated in details through specific embodiments. The following specific embodiments may be combined with each other, and same or similar concepts or procedures will not be repeated in some embodiments. The embodiment of the present disclosure will be described below in conjunction with the accompanying drawings.

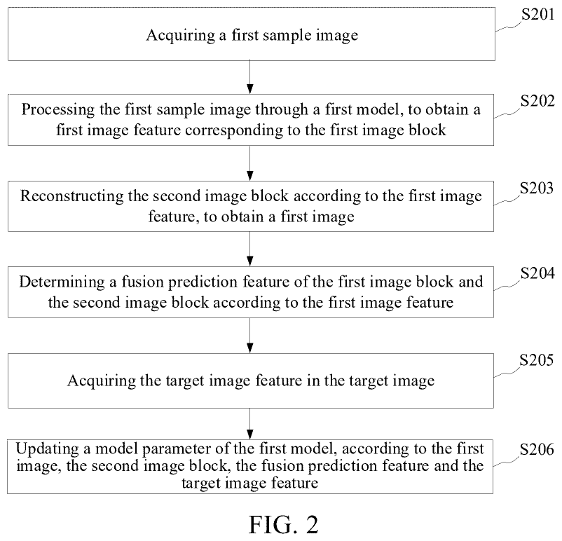

FIG. 2 is a schematic flow chart of a model training method provided by an embodiment of the present disclosure. Referring to FIG. 2, the method may include:

S201: acquiring a first sample image.

An executing body according to the embodiment of the present disclosure may be an electronic device, or may also be a model training apparatus provided in the electronic device. Optionally, the model training apparatus may be implemented through software; or the model training apparatus may also be implemented through a combination of software and hardware.

Optionally, the first sample image is used for training the first model. Optionally, the first sample image includes a plurality of image blocks. For example, if a size of the first sample image is 224*224, then the first sample image may be divided into 14*14 (196) image blocks without overlapping regions, or the first sample image may also be divided into image blocks of any size without overlapping regions, which will not be limited in the embodiments of the present disclosure.

Optionally, the respective image blocks in the first sample image include corresponding identifiers. For example, the first sample image includes 196 non-overlapping image blocks; each image block has a unique sequence number; and the electronic device may determine a position of the image block in the first sample image through a sequence number corresponding to the image block.

Optionally, the plurality of image blocks include first image blocks which are uncovered and second image blocks which are covered. For example, the first sample image includes an image block A, an image block B and an image block C. If the image block A is covered, then the first image block is the image block B and the image block C, and the second image block is the image block A.

Optionally, the electronic device may cover a plurality of image blocks in the first sample image through a cover region. For example, if a preset cover ratio is 0.5, and the first sample image includes 100 image blocks, then a size of a cover mask may be set to a size of 50 image blocks, and further the first sample image is covered with the cover mask. For example, if the first sample image includes 100 non-overlapping image blocks, and a preset cover ratio is 0.5, then 50 masks each having a size the same as an image block may be set, and further 50 image blocks may be randomly covered by the 50 masks. Optionally, the cover ratio in the first sample image may be any ratio, which will not be limited in the embodiment of the present disclosure.

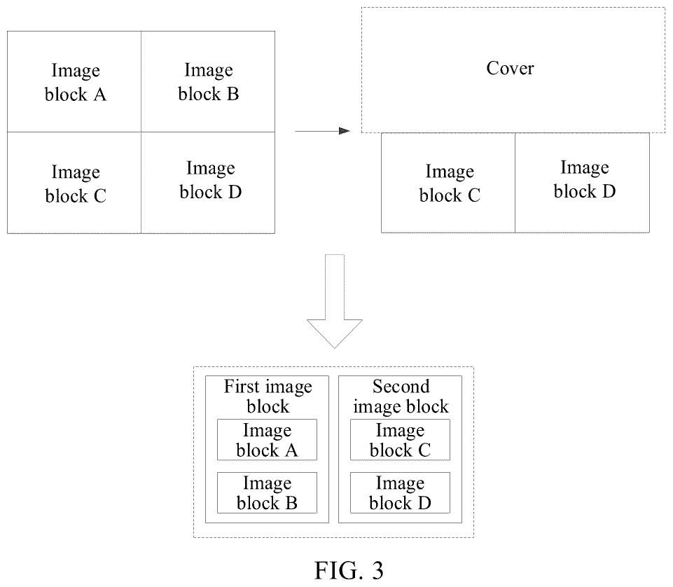

Hereinafter, the first sample image will be illustrated in conjunction with FIG. 3.

FIG. 3 is a schematic diagram of a first sample image provided by an embodiment of the present disclosure. Referring to FIG. 3, which includes the image block A, the image block B, the image block C and the image block D. For example, the image block A, the image block B, the image block C and the image block D do not overlap with each other. If content of the image block A and content of the image block B are covered, then the first image block includes the image block C and the image block D, and the second image block includes the image block A and the image block B.

S202: processing the first sample image through a first model to obtain a first image feature corresponding to the first image block.

Optionally, the first model may be a neural network model; and the image feature of the image may be acquired through the first model. For example, the first model may be a convolutional neural network (CNN); and accuracy of feature extraction of the CNN may be improved by adjusting a parameter in the CNN.

Optionally, because the first image block is an image block which is uncovered in the first sample image, the first image feature corresponding to the first image block may be obtained according to a feasible implementation as follows: performing feature extraction on the first image block in the first sample image, to obtain the first image feature corresponding to the first image block. For example, because the first image block is the uncovered image block, the first model may directly recognize the image content in the first image block, and further obtain the first image feature corresponding to the first image block. For example, the first model includes an online encoder. Upon receiving the recognizable first image block, the online encoder may map the first image block to a feature space, and further obtain the encoded feature of the first image block.

Optionally, the first image feature may be a vector feature. For example, the first image feature may be a 768-dimensional feature vector; and if the first sample image includes 100 image blocks, then after processing the first sample image through the first model, each image block will correspond to a 768-dimensional feature vector.

S203: reconstructing the second image block according to the first image feature, to obtain a first image.

Optionally, the electronic device may reconstruct image content in the second image block which is covered through the first image feature corresponding to the first image block which is uncovered, to further obtain the first image. For example, the electronic device may include an online decoder; when receiving the first image feature corresponding to the first image block, the online decoder may input the first image feature into a pixel decoder (a feature of the second image block which is covered may be replaced by a placeholder); and the pixel decoder may predict the first image corresponding to the second image block which is uncovered according to the first image feature.

S204: determining a fusion prediction feature of the first image block and the second image block according to the first image feature.

Optionally, the fusion prediction feature is used for indicating a fusion feature of the first image block and the second image block. For example, the first image block and the second image block may form an image; the second image block is a covered image block; and the electronic device may predict the fusion prediction feature of the first image block and the second image block after fusion through the first image feature of the first image block.

Optionally, the electronic device may determine the fusion prediction feature of the first image block and the second image block according to a feasible implementation as follows: acquiring a preset first vector. Optionally, the first vector may be a vector corresponding to a predicted second image block. For example, the electronic device may include an online decoder. When receiving the first image feature corresponding to the first image block, the online decoder may predict the first vector corresponding to the second image block according to the first image feature.

The first vector and the first image feature are fused to obtain a fusion vector. For example, when the electronic device obtains the first image feature corresponding to the first image block, the electronic device may fill in the feature corresponding to the second image block through a placeholder according to a sequence number of the second image block in the first sample image; when receiving the first image feature, the online decoder may predict the feature vector corresponding to the second image block and replace the placeholder with the feature vector, to further obtain the fusion vector.

The fusion prediction feature is obtained according to the fusion vector. For example, the online decoder includes a feature decoder. When obtaining the fusion vector, the online decoder in the electronic device may input the fusion vector into the feature decoder; and the feature decoder may obtain the fusion prediction feature of the first image block and the second image block according to the fusion vector.

S205: acquiring the target image feature in the target image.

Optionally, the target image is an image after preprocessing of the first sample image. Optionally, preprocessing may be a processing method for changing an image attribute. For example, preprocessing may include adjusting image brightness, adjusting image color, adjusting image contrast, adjusting image grayscale, adjusting image size, or other image processing methods, which will not be limited in the embodiments of the present disclosure. For example, enhanced display processing is performed on the first sample image to obtain the target image; brightness of the first sample image is increased to obtain the target image; or a portion of the first sample image is cropped to obtain the target image, etc.

Optionally, the target image may include a plurality of image blocks. For example, the first sample image includes 100 image blocks; if enhanced display processing is performed on the first sample image to obtain the target image, then the target image may also include 100 image blocks. Optionally, all image blocks in the target image are first image blocks which is uncovered.

Hereinafter, the procedure of acquiring the target image will be illustrated in conjunction with FIG. 4.

FIG. 4 is a schematic diagram of a procedure of acquiring a target image provided by an embodiment of the present disclosure. Referring to FIG. 4, it includes the first sample image and the target image. For example, the first sample image includes the image block A, the image block B, the image block C and the image block D. A grayscale value in the first sample image is adjusted to obtain the target image; and the target image includes the image block 1, the image block 2, the image block 3 and the image block 4. For example, the image block 1 is an image block after adjusting a grayscale value of the image block A; the image block 2 is an image block after adjusting a grayscale value of the image block B; the image block 3 is an image block after adjusting a grayscale value of the image block C; and the image block 4 is an image block after adjusting a grayscale value of the image block D.

Optionally, the acquiring, by the electronic device, the target image feature in the target image includes two cases as follows:

Case 1: determining the image feature of the target image as the target image feature.

Optionally, the electronic device may process the target image to further obtain the target image feature corresponding to the target image. For example, the electronic device may process the target image through an encoder to further obtain a feature map corresponding to the target image.

Case 2: determining the image feature of a portion of image of the target image as the target image feature.

Optionally, the electronic device may obtain the target image feature through a feasible implementation as follows: determining a first region in the target image according to a position of the second image block in the first sample image. For example, if the second image block is in a middle region of the first sample image, then the middle region in the target image is determined as the first region; if the second image block is in an upper region in the first sample image, then the upper region of the target image is determined as the first region. Optionally, a size of the first region may be the same as a sum of sizes of a plurality of second image blocks. For example, if the first sample image includes 10 second image blocks, and each second image block has a length of 10 pixel units and a width of 10 pixel units, then the first region has a length of 100 pixel units and a width of 100 pixel units; and the first region may have other size, which will not be limited in the embodiments of the present disclosure.

Offset processing is performed on the first region to obtain a second region. For example, the electronic device may offset the first region in any direction by any distance in the target image, to further obtain the second region. In this way, the image content in the second region is similar to the image content in the first region, to further improve an effect of model training.

The image feature corresponding to the image block within the second region in the target image is acquired and determined as the target image feature. For example, the target image includes a plurality of image blocks; after the electronic device determines the second region, the electronic device may determine the image feature corresponding to the image block within the second region as the target image feature.

Optionally, the electronic device may randomly select a portion of image region in the target image and determine the feature corresponding to the image within the image region as the target image feature. For example, the electronic device may arbitrarily acquire an image of a preset size in the target image, and determine the image feature corresponding to the image as the target image feature; wherein, the preset size may be the same as the size of the covered region in the first sample image, or may also be different from the size of the covered region in the first sample image, which will not be limited in the embodiments of the present disclosure.

Optionally, the electronic device may process the target image through a target encoder to obtain the target image feature corresponding to the target image. Optionally, the target encoder is used for acquiring the image feature in the target image. For example, the electronic device includes an online encoder, and may acquire first image features of a plurality of image blocks in the first sample image through the online encoder; and the electronic device may also obtain a second image feature corresponding to the target image through the target encoder.

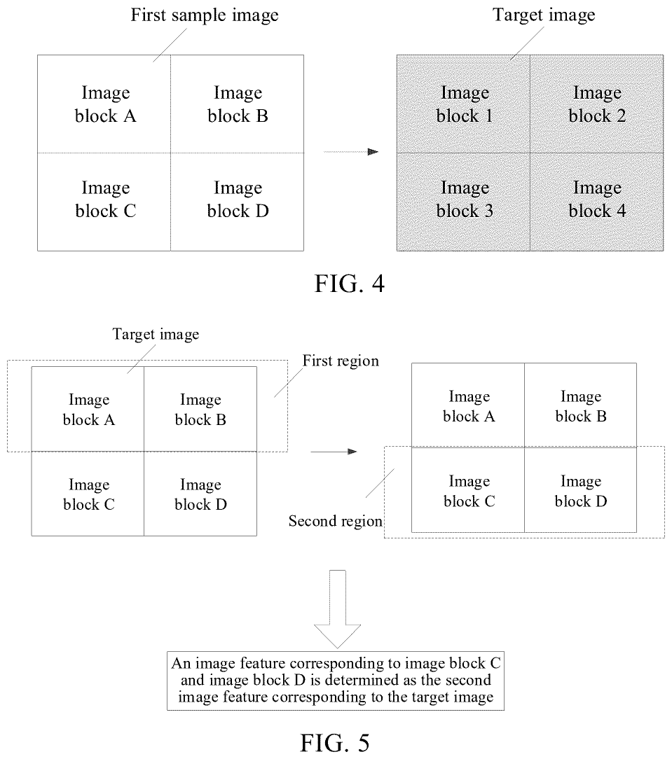

Hereinafter, a procedure of acquiring the target image feature in the target image will be illustrated in conjunction with FIG. 5.

FIG. 5 is a schematic diagram of a procedure of acquiring a target image feature provided by an embodiment of the present disclosure. Referring to FIG. 5, it includes the target image. For example, the target image includes image block A, image block B, image block C and image block D. A first region in the target image includes image block A and image block B. The first region is offset downwards to obtain a second region. The second region includes image block C and image block D. An image feature corresponding to image block C and image block D is determined as the target image feature corresponding to the target image.

S206: updating the model parameter of the first model, according to the first image, the second image block, the fusion prediction feature and the target image feature.

Optionally, the model parameter of the first model may be updated according to a feasible implementation as follows: determining a first loss function of the first model according to the first image and the second image block. For example, the electronic device determines the first loss function of the first model through a difference between the first image and the second image block, and then updates the first model through the first loss function.

Optionally, the first loss function may be determined according to a formula as follows:

$${L}_{1} = \frac{1}{n} {\sum }_{i ∈ M} {( {x}_{i} - {y}_{i} )}^{2}$$

Where, L₁ is the first loss function; M is the number of second image blocks; n is the number of image blocks in the first sample image; xᵢ is the first image; yᵢ is the second image block; and i is a sequence number of the second image block.

The second loss function of the first model is determined according to the fusion prediction feature and the target image feature. For example, the electronic device obtains the second loss function through a relationship between the fusion prediction feature of the first image block and the second image block and the target image feature in the target image, and updates the model parameter in the first model through the second loss function.

The model parameter of the first model is updated according to the first loss function and the second loss function. For example, the electronic device may update the first model through the first loss function between the first image and the second image block, and the second loss function between the fusion prediction feature and the target image feature, so that the first model may not only learn an association relationship between images, but also learn an association relationship between the respective regions within the image, to further improve a effect of model training.

The embodiment of the present disclosure provides a model training method, including: acquiring the first sample image; processing the first image block which is uncovered in the first sample image through the first model to obtain the first image feature corresponding to the first image block; reconstructing the second image block which is covered in the first sample image according to the first image feature, to obtain the first image; determining the fusion prediction feature of the first image block and the second image block according to the first image feature; processing the first sample image by means of image enhancement, contrast improvement, etc., to obtain the target image; further determining the target image feature required for comparative learning in the target image; obtaining the first loss function according to the first image and the second image block; obtaining the second loss function through the fusion prediction feature and the target image feature; and updating the model parameter of the first model through the first loss function and the second loss function. In this way, because the first loss function may indicate the association relationship between respective regions inside the image, and the second loss function may indicate the association relationship between images, the first model may learn region feature inside the image and the feature between images, to further improve an effect of model training.

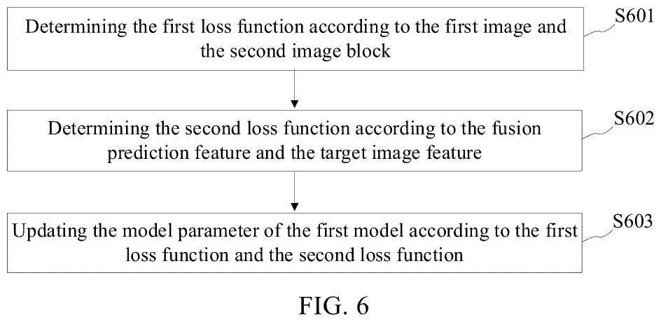

The above-described model processing method further includes a method of updating the model parameter of the first model. On the basis of the embodiment shown in FIG. 2, the method of updating the model parameter of the first model will be illustrated below in conjunction with FIG. 6.

FIG. 6 is a schematic flow chart of a method of updating a model parameter provided by an embodiment of the present disclosure. Referring to FIG. 6, the method includes:

S601: determining the first loss function according to the first image and the second image block.

It should be noted that step S205 may be referred to for an execution process of step S601; and no details will be repeated in the embodiment of the present disclosure.

S602: determining the second loss function according to the fusion prediction feature and the target image feature.

Optionally, the second loss function may be determined according to a feasible implementation as follows: acquiring a second sample image; and determining a second image feature of the second sample image. Optionally, the second sample image is any image other than the first sample image. For example, in the procedure of self-supervised learning of the first model, a training set of the first model may include a plurality of training sample images; when learning one of the training sample images, the other training sample images are all second sample images.

Optionally, the second sample image may be encoded by an encoder, to obtain the second image feature corresponding to the second sample image. For example, the second sample image is a comparative sample (negative sample) in self-supervised learning; and the electronic device may encode the image feature of the second sample image through a target encoder to obtain the second image feature.

The second loss function is determined according to the fusion prediction feature, the target image feature, and the second image feature. Optionally, the second loss function may be determined according to a feasible implementation as follows: acquiring a first similarity between the fusion prediction feature and the target image feature. For example, the first similarity may be a cosine similarity, a Euclidean distance, etc., which will not be limited in the embodiments of the present disclosure. For example, each image block in the target image corresponds to a 768-dimensional vector space; before acquiring the first similarity, the electronic device may merge a plurality of 768-dimensional vector spaces corresponding to a plurality of image blocks into one feature vector, to further determine the cosine similarity between the feature vector and the fusion prediction feature, and determine the cosine similarity as the first similarity.

A second similarity between the fusion prediction feature and the second image feature is acquired. For example, feature vectors corresponding to respective image blocks in the second sample image are merged into one feature vector, to further determine the cosine similarity between the feature vector and the fusion prediction feature merged, and further the cosine similarity is determined as the second similarity.

The second loss function is determined according to the first similarity and the second similarity. Optionally, a second parameter may be determined according to a formula as follows:

$${L}_{2} = - log \frac{exp ( {s}^{+} / τ )}{exp ( {s}^{+} / τ ) + \sum exp ( {s}^{-} / τ )}$$

Where, L₂ is the second parameter; s⁺ is the cosine similarity (first similarity) between positive samples; s⁻ is the cosine similarity (second similarity) between the positive sample and the negative sample; τ is a coefficient that controls learning difficulty (which may be an arbitrary value, for example, 0.07).

S603: updating the model parameter of the first model according to the first loss function and the second loss function.

Optionally, the model parameter of the first model may be updated according to a feasible implementation as follows: acquiring a first weight corresponding to the first loss function and a second weight corresponding to the second loss function; and updating the model parameter of the first model according to the first parameter, the first loss function, the second parameter and the second loss function. Optionally, the first weight and the second weight may be preset arbitrary values; and a sum of the first weight and the second weight is 1. For example, if the first weight is 0.3, then the second weight may be 0.7; and the electronic device may adjust the first weight and the second weight according to needs, and further adjust a focus direction of first model learning (e.g., focusing on the association relationship within the image, or focusing on the association relationship between images), to further improve flexibility of model training and an effect of model training.

The embodiment of the present disclosure provides the method for updating the model parameter, including: determining the first loss function according to the first image and the first image block; determining the second loss function according to the fusion prediction feature and the target image feature; and updating the model parameter of the first model according to the first loss function and the second loss function. In this way, the electronic device may accurately train the first model through the first loss function and the second loss function, to improve accuracy of model training. Moreover, because the first weight corresponding to the first loss function and the second weight corresponding to the second loss function may flexibly adjust the focus of first model learning, flexibility of model training may be improved, to further improve an effect of model training.

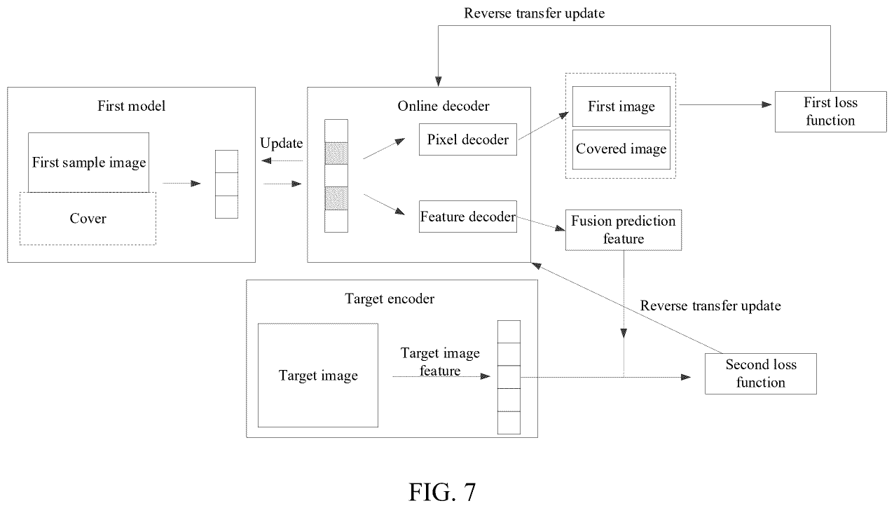

On the basis of any one of the above-described embodiments, a procedure of the above-described model training method will be illustrated in conjunction with FIG. 7.

FIG. 7 is a schematic diagram of a procedure of a model training method provided by an embodiment of the present disclosure. Referring to FIG. 7, which includes the first model, the online decoder and the target encoder. The first model includes the first sample image; and the first sample image includes the covered region. The first model processes the uncovered region in the first sample image, to obtain 3 first image features corresponding to the uncovered region. The online encoder acquires the 3 first image features, predicts the feature of the covered region in the first sample image, and adds a predicted feature to the 3 first image features. The pixel decoder processes the first image feature having the feature added, reconstructs the image of the covered region, obtains the first image, and obtains the first loss function through the covered image in the first image and the first sample image.

Referring to FIG. 7, the target encoder acquires the target image; the target image is an image after performing enhanced display on the first sample image. The target encoder generates a target image feature corresponding to the target image. The feature decoder processes the first image feature after adding the feature, to obtain the fusion prediction feature of the covered region and the uncovered region. The second loss function is obtained through the fusion prediction feature and the target image feature. It should be noted that in the embodiment shown in FIG. 7, the second loss function may also be determined by combining the negative sample (the second sample image, not shown in FIG. 7).

Referring to FIG. 7, reverse gradient transfer is performed on the online decoder and the first model through the first loss function and the second loss function, to further update the model parameter in the first model. For example, in the procedure of training the first model, the parameter of the online decoder may also be updated through the first loss function and the second loss function (the first model is continuously trained, and the parameter of the online decoder is also continuously updated). In an actual use procedure, the image feature needs to be extracted only through the first model, without the online decoder and the target encoder.

Optionally, in the procedure of training the first model, the parameter in the target encoder may also be updated, and the parameter in the target encoder may be updated through a formula as follows:

$${W}_{T}^{k} = α {W}_{O}^{k} + ( 1 - α ) {W}_{T}^{k - 1}$$

Where,

$${W}_{T}^{k}$$

is a network weight of the target encoder in step k;

$${W}_{O}^{k}$$

is a network weight of the online encoder in step k; and α is a hyperparameter (e.g., α may be 0.9). In this way, the parameter in the target encoder may be updated through the network weight of the online encoder and the network weight when the target encoder is updated last time, to further improve a training effect of the first model.

According to the above-described method, the first model may learn the association relationship between respective regions inside the first sample image through the first image of the reconstructed covered region and the image of the covered region in the first sample image; and the first model may also learn the association relationship between images through the fusion prediction feature and the target image feature, to further improve the model training effect of the first model.

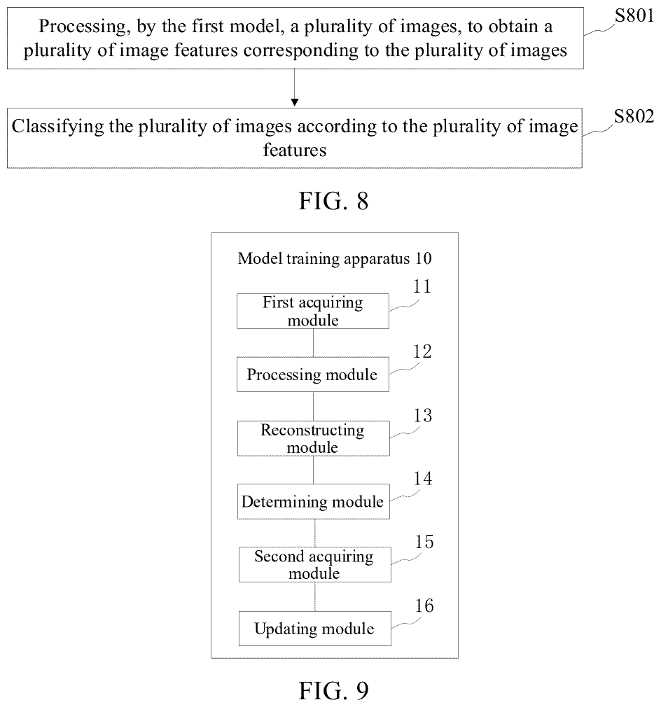

An embodiment of the present disclosure further includes an image processing method. Hereinafter, the flow of the image processing method will be illustrated in conjunction with FIG. 8.

FIG. 8 is a schematic flow chart of an image processing method provided by an embodiment of the present disclosure. Referring to FIG. 8, the flow of the method includes:

S801: processing, by the first model, a plurality of images, to obtain a plurality of image features corresponding to the plurality of images.

Optionally, the first model is a model obtained through training of reconstructed image comparative learning combined with predicted feature comparative learning. Optionally, the first model may be the first model according to any one of the above-described embodiments. For example, the first model may be the first model according to the embodiments shown in FIG. 2 and FIG. 6.

S802: classifying the plurality of images according to the plurality of image features.

Optionally, the plurality of images may be classified according to a feasible implementation as follows: acquiring a similarity between two image features corresponding to any two images; and classifying the plurality of images through the similarity to obtain an image classification result. For example, when a similarity between image features corresponding to two images is greater than or equal to a first threshold, it is determined that the two images are images of a same class; and when a similarity between image features corresponding to two images is less than the first threshold, it is determined that the two images are images of different classes. For example, an image set includes image A, image B, image C and image D; if a similarity between an image feature of image A and an image feature of image B is greater than the first threshold, a similarity between an image feature of image C and an image feature of image D is greater than the first threshold, and a similarity between the image feature of image A or image B and the image feature of image C or image D is less than the first threshold, then the electronic device classifies image A and image B into one class of images, and classifies image C and image D into another class of images.

The image processing method provided by the embodiment of the present disclosure includes: processing the plurality of images through the first model to obtain the plurality of image features corresponding to the plurality of images; and classifying the plurality of images according to the plurality of image features. Because the first model is a model obtained through training of reconstructed image comparative learning combined with predicted feature comparative learning, the first model may learn the association relationship between the respective regions inside the image and the association relationship between images, to further improve a training effect of the first model, make accuracy of the image feature output by the first model higher, and improve accuracy of image classification.

FIG. 9 is a structural schematic diagram of a model training apparatus provided by an embodiment of the present disclosure. Referring to FIG. 9, the model training apparatus 10 includes a first acquiring module 11, a processing module 12, a reconstructing module 13, a determining module 14, a second acquiring module 15, and an updating module 16, for example:

The first acquiring module 11 is configured to acquire a first sample image; the first sample image including a first image block which is uncovered and an second image block which is covered;

The processing module 12 is configured to process the first sample image through a first model, to obtain a first image feature corresponding to the first image block;

The reconstructing module 13 is configured to reconstruct the second image block according to the first image feature, to obtain the first image;

The determining module 14 is configured to determine a fusion prediction feature of the first image block and the second image block according to the first image feature;

The second acquiring module 15 is configured to acquire a target image feature in a target image; the target image being an image after preprocessing the first sample image;

The updating module 16 is configured to update a model parameter of the first model, according to the first image, the second image block, the fusion prediction feature and the target image feature.

In one possible implementation, the updating module 16 is specifically configured to:

Determine a first loss function of the first model, according to the first image and the second image block;

Determine a second loss function of the first model, according to the fusion prediction feature and the target image feature; and

Update the model parameter of the first model, according to the first loss function and the second loss function.

In one possible implementation, the updating module 16 is specifically configured to:

Acquire a second sample image, and determine a second image feature of the second sample image; the second sample image being an image other than the first sample image; and

Determine the second loss function, according to the fusion prediction feature, the target image feature, and the second image feature.

In one possible implementation, the updating module 16 is specifically configured to:

Acquire a first similarity between the fusion prediction feature and the target image feature;

Acquire a second similarity between the fusion prediction feature and the second image feature; and

Determine the second loss function according to the first similarity and the second similarity.

In one possible implementation, the updating module 16 is specifically configured to:

Acquire a first weight corresponding to the first loss function and a second weight corresponding to the second loss function; and

Update the model parameter of the first model according to the first loss function, the first weight, the second loss function and the second weight.

In one possible implementation, the determining module 14 is specifically configured to:

Acquire a first vector;

Fuse the first vector and the first image feature, to obtain a fusion vector; and

Obtain the fusion prediction feature according to the fusion vector.

In one possible implementation, the second acquiring module 15 is specifically configured to:

Determine a first region in the target image, according to a position of the second image block in the first sample image;

Perform offset processing on the first region, to obtain a second region; and

Determine an image feature corresponding to the image block within the second region in the target image as the target image feature.

The model training apparatus provided by the embodiment of the present disclosure may be used to execute the technical solution of the above-described method embodiment, and has similar implementation principle and technical effect; and no details will be repeated here in this embodiment.

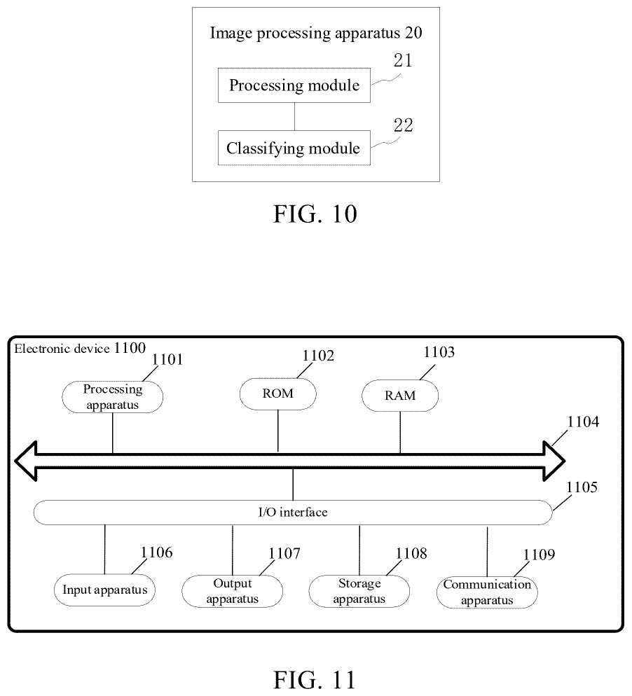

FIG. 10 is a structural schematic diagram of an image processing apparatus provided by an embodiment of the present disclosure. Referring to FIG. 10, the image processing apparatus 20 includes a processing module 21 and a classifying module 22, for example:

The processing module 21 is configured to process a plurality of images through a first model, to obtain a plurality of image features corresponding to the plurality of images; the first model being a model obtained through training of reconstructed image comparative learning combined with predicted feature comparative learning;

The classifying module 22 is configured to classify the plurality of images according to the plurality of image features.

The image processing apparatus provided by the embodiment of the present disclosure may be used to execute the technical solution of the above-described method embodiment, and has similar implementation principle and technical effect; and no details will be repeated here in this embodiment.

FIG. 11 is a structural schematic diagram of an electronic device provided by an embodiment of the present disclosure. Referring to FIG. 11, which shows a structural schematic diagram of an electronic device 1100 suitable for implementing the embodiment of the present disclosure; the electronic device 1100 may be a terminal device or an electronic device. Wherein, the terminal device may include but is not limited to mobile terminals such as a mobile phone, a laptop, a digital broadcasting receiver, a personal digital assistant (PDA), a portable android device (PAD), a portable media player (PMP), a vehicle-mounted terminal (e.g., a vehicle-mounted navigation terminal), and fixed terminals such as a digital TV, a desktop computer, etc. The electronic device shown in FIG. 11 is only an example and should not impose any limitations on the functionality and scope of use of the embodiment of the present disclosure.

As shown in FIG. 11, the electronic device 1100 may include a processing apparatus (such as a central processing unit, and a graphics processor) 1101, it may execute various appropriate actions and processes according to a program stored in a read-only memory (ROM) 1102 or a program loaded from a storage apparatus 1108 to a random access memory (RAM) 1103. In RAM 1103, various programs and data required for operations of the electronic device 1100 are also stored. The processing apparatus 1101, ROM 1102, and RAM 1103 are connected to each other by a bus 1104. An input/output (I/O) interface 1105 is also connected to the bus 1104.

Typically, the following apparatuses may be connected to the I/O interface 1105: an input apparatus 1106 such as a touch screen, a touchpad, a keyboard, a mouse, a camera, a microphone, an accelerometer, and a gyroscope; an output apparatus 1107 such as a liquid crystal display (LCD), a loudspeaker, and a vibrator; a storage apparatus 1108 such as a magnetic tape, and a hard disk drive; and a communication apparatus 1109. The communication apparatus 1109 may allow the electronic device 1100 to wireless-communicate or wire-communicate with other devices so as to exchange data. Although FIG. 11 shows the electronic device 1100 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 1109, or installed from the storage apparatus 1108, or installed from ROM 1102. When the computer program is executed by the processing apparatus 1101, the above functions defined in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The above-described computer readable medium may be included in the above-described server; or may also exist separately without being assembled into the server.

The above-described computer readable medium carries one or more programs; and the above-described one or more programs, when executed by the server, cause the server to execute the method shown in the above-described embodiment.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The units involved in the embodiments of the present disclosure may be implemented by software or hardware. For example, a name of the unit does not constitute limitation of the unit per se in some cases; for example, a first acquiring unit may also be described as “a unit that acquires at least two Internet protocol addresses”.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

In a first aspect, an embodiment of the present disclosure provides a model training method, and the method includes:
acquiring a first sample image; the first sample image including a first image block which is uncovered and a second image block which is covered;
processing the first sample image through a first model, to obtain a first image feature corresponding to the first image block;
reconstructing the second image block according to the first image feature, to obtain a first image; and determining a fusion prediction feature of the first image block and the second image block, according to the first image feature;
acquiring a target image feature in a target image; the target image being an image after preprocessing the first sample image; and
updating a model parameter of the first model, according to the first image, the second image block, the fusion prediction feature and the target image feature.

According to one or more embodiments of the present disclosure, the updating a model parameter of the first model, according to the first image, the second image block, the fusion prediction feature and the target image feature, includes:
determining a first loss function of the first model, according to the first image and the second image block;
determining a second loss function of the first model, according to the fusion prediction feature and the target image feature; and
updating the model parameter of the first model, according to the first loss function and the second loss function.

According to one or more embodiments of the present disclosure, the determining a second loss function of the first model, according to the fusion prediction feature and the target image feature, includes:
acquiring a second sample image, and determining a second image feature of the second sample image; the second sample image being an image other than the first sample image; and
determining the second loss function according to the fusion prediction feature, the target image feature, and the second image feature.

According to one or more embodiments of the present disclosure, the determining the second loss function according to the fusion prediction feature, the target image feature, and the second image feature, includes:
acquiring a first similarity between the fusion prediction feature and the target image feature;
acquiring a second similarity between the fusion prediction feature and the second image feature; and
determining the second loss function according to the first similarity and the second similarity.

According to one or more embodiments of the present disclosure, the updating the model parameter of the first model, according to the first loss function and the second loss function, includes:
acquiring a first weight corresponding to the first loss function and a second weight corresponding to the second loss function; and
updating a model parameter of the first model according to the first loss function, the first weight, the second loss function and the second weight.

According to one or more embodiments of the present disclosure, the determining a fusion prediction feature of the first image block and the second image block, according to the first image feature, includes:
acquiring a first vector;
fusing the first vector and the first image feature, to obtain a fusion vector; and
obtaining the fusion prediction feature according to the fusion vector.

According to one or more embodiments of the present disclosure, the acquiring a target image feature in a target image, includes:
determining a first region in the target image, according to a position of the second image block in the first sample image;
performing offset processing on the first region, to obtain a second region; and
determining an image feature corresponding to an image block within the second region in the target image as the target image feature.

In a second aspect, an embodiment of the present disclosure provides an image processing method, and the method includes:
processing a plurality of images through a first model, to obtain a plurality of image features corresponding to the plurality of images; the first model being a model obtained through training of reconstructed image comparative learning combined with predicted feature comparative learning; optionally, the first model being the first model according to any item of the first aspect; and
classifying the plurality of images, according to the plurality of image features.

In a third aspect, an embodiment of the present disclosure provides a model training apparatus; and the model training apparatus includes a first acquiring module, a processing module, a reconstructing module, a determining module, a second acquiring module and an updating module, wherein:
the first acquiring module is configured to acquire a first sample image; the first sample image including a first image block which is uncovered and an second image block which is covered;
the processing module is configured to process the first sample image through the first model, to obtain a first image feature corresponding to the first image block;
the reconstructing module is configured to reconstruct the second image block according to the first image feature, to obtain a first image;
the determining module is configured to determine a fusion prediction feature of the first image block and the second image block according to the first image feature;
the second acquiring module is configured to obtain a target image feature in a target image; the target image being an image after preprocessing the first sample image; and
the updating module is configured to update a model parameter of the first model, according to the first image, the second image block, the fusion prediction feature and the target image feature.

In one possible implementation, the updating module is specifically configured to:
determine a first loss function of the first model, according to the first image and the second image block;
determine a second loss function of the first model, according to the fusion prediction feature and the target image feature; and
update the model parameter of the first model, according to the first loss function and the second loss function.

In one possible implementation, the updating module is specifically configured to:
acquire a second sample image, and determine a second image feature of the second sample image; the second sample image being an image other than the first sample image; and
determine the second loss function according to the fusion prediction feature, the target image feature, and the second image feature.

In one possible implementation, the updating module is specifically configured to:
acquire a first similarity between the fusion prediction feature and the target image feature;
acquire a second similarity between the fusion prediction feature and the second image feature; and
determine the second loss function according to the first similarity and the second similarity.

In one possible implementation, the updating module is specifically configured to:
acquire a first weight corresponding to the first loss function and a second weight corresponding to the second loss function; and
update the model parameter of the first model according to the first loss function, the first weight, the second loss function and the second weight.

In one possible implementation, the determining module is specifically configured to:
acquire a first vector;
fuse the first vector and the first image feature, to obtain a fusion vector; and
obtain the fusion prediction feature according to the fusion vector.

In one possible implementation, the second acquiring module is specifically configured to:
determine a first region in the target image, according to a position of the second image block in the first sample image;
perform offset processing on the first region, to obtain a second region; and
determine an image feature corresponding to an image block within the second region in the target image as the target image feature.

In a fourth aspect, an embodiment of the present disclosure provides an image processing apparatus; and the image processing apparatus includes a processing module and a classifying module, wherein:
the processing module is configured to process a plurality of images through a first model, to obtain a plurality of image features corresponding to the plurality of images; the first model being a model obtained through training of reconstructed image comparative learning combined with predicted feature comparative learning; and the classifying module is configured to classify the plurality of images according to
the plurality of image features.

In a fifth aspect, an embodiment of the present disclosure provides an electronic device, including: a processor and a memory;
the memory stores computer execution instructions; and
the processor executes the computer execution instructions stored in the memory, so that the at least one processor executes the model training method that may be involved in the first aspect and various possibilities of the first aspect, or the image processing method that may be involved in the second aspect and various possibilities of the second aspect.

In a sixth aspect, an embodiment of the present disclosure provides a computer readable storage medium, having computer execution instructions stored therein; wherein, the processor, when executing the computer execution instructions, implements the model training method that may be involved in the first aspect and various possibilities of the first aspect, or the image processing method that may be involved in the second aspect and various possibilities of the second aspect.

In a seventh aspect, an embodiment of the present disclosure provides a computer program product, including a computer program; wherein, the computer program, when executed by a processor, implements the model training method that may be involved in the first aspect and various possibilities of the first aspect, or the image processing method that may be involved in the second aspect and various possibilities of the second aspect.

In an eighth aspect, an embodiment of the present disclosure provides a computer program, wherein, the computer program, when executed by a processor, implements the model training method that may be involved in the first aspect and various possibilities of the first aspect, or the image processing method that may be involved in the second aspect and various possibilities of the second aspect.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

1. A model training method, comprising:
acquiring a first sample image, wherein the first sample image comprises a first image block which is uncovered and a second image block, which is covered;
processing the first sample image through a first model, to obtain a first image feature corresponding to the first image block;
reconstructing the second image block according to the first image feature, to obtain a first image, and determining a fusion prediction feature of the first image block and the second image block, according to the first image feature;
acquiring a target image feature in a target image, wherein the target image is an image after preprocessing of the first sample image; and
updating a model parameter of the first model, according to the first image, the second image block, the fusion prediction feature and the target image feature.

2. The method according to claim 1, wherein, the updating a model parameter of the first model, according to the first image, the second image block, the fusion prediction feature and the target image feature, comprises:
determining a first loss function of the first model, according to the first image and the second image block;
determining a second loss function of the first model, according to the fusion prediction feature and the target image feature; and
updating the model parameter of the first model, according to the first loss function and the second loss function.

3. The method according to claim 2, wherein, the determining a second loss function of the first model, according to the fusion prediction feature and the target image feature, comprises:
acquiring a second sample image, and determining a second image feature of the second sample image, wherein the second sample image is an image other than the first sample image; and
determining the second loss function according to the fusion prediction feature, the target image feature, and the second image feature.

4. The method according to claim 3, wherein, the determining the second loss function according to the fusion prediction feature, the target image feature, and the second image feature, comprises:
acquiring a first similarity between the fusion prediction feature and the target image feature;
acquiring a second similarity between the fusion prediction feature and the second image feature; and
determining the second loss function according to the first similarity and the second similarity.

5. The method according to claim 2, wherein, the updating the model parameter of the first model, according to the first loss function and the second loss function, comprises:
acquiring a first weight corresponding to the first loss function and a second weight corresponding to the second loss function; and
updating the model parameter of the first model according to the first loss function, the first weight, the second loss function and the second weight.

6. The method according to claim 1, wherein, the determining a fusion prediction feature of the first image block and the second image block, according to the first image feature, comprises:
acquiring a first vector;
fusing the first vector and the first image feature, to obtain a fusion vector; and
obtaining the fusion prediction feature according to the fusion vector.

7. The method according to claim 1, wherein, the acquiring a target image feature in a target image, comprises:
determining a first region in the target image, according to a position of the second image block in the first sample image;
performing offset processing on the first region, to obtain a second region; and
determining an image feature corresponding to an image block within the second region in the target image as the target image feature.

8. An image processing method, comprising:
processing a plurality of images through a first model, to obtain a plurality of image features corresponding to the plurality of images, wherein the first model is a model obtained through training of reconstructed image comparative learning combined with predicted feature comparative learning; and
classifying the plurality of images, according to the plurality of image features.

9-10. (canceled)

11. An electronic device, comprising: a processor and a memory; wherein,
the memory stores computer execution instructions; and
the processor executes the computer execution instructions stored in the memory, so that the processor executes a model training method which comprises:
acquiring a first sample image, wherein the first sample image comprises a first image block which is uncovered and a second image block, which is covered;
processing the first sample image through a first model, to obtain a first image feature corresponding to the first image block;
reconstructing the second image block according to the first image feature, to obtain a first image, and determining a fusion prediction feature of the first image block and the second image block, according to the first image feature;
acquiring a target image feature in a target image, wherein the target image is an image after preprocessing of the first sample image; and
updating a model parameter of the first model, according to the first image, the second image block, the fusion prediction feature and the target image feature.

12. A non-transitory computer readable storage medium, having computer execution instructions stored therein, wherein, the processor, upon executing the computer execution instructions, implements the model training method according to claim 1.

13-14. (canceled)

15. An electronic device, comprising: a processor and a memory; wherein,
the memory stores computer execution instructions; and
the processor executes the computer execution instructions stored in the memory, so that the processor executes the image processing method according to claim 8.

16. A non-transitory computer readable storage medium, having computer execution instructions stored therein, wherein, the processor, upon executing the computer execution instructions, implements the image processing method according to claim 8.

17. The electronic device according to claim 11, wherein, the updating a model parameter of the first model, according to the first image, the second image block, the fusion prediction feature and the target image feature, comprises:
determining a first loss function of the first model, according to the first image and the second image block;
determining a second loss function of the first model, according to the fusion prediction feature and the target image feature; and
updating the model parameter of the first model, according to the first loss function and the second loss function.

18. The electronic device according to claim 17, wherein, the determining a second loss function of the first model, according to the fusion prediction feature and the target image feature, comprises:
acquiring a second sample image, and determining a second image feature of the second sample image, wherein the second sample image is an image other than the first sample image; and
determining the second loss function according to the fusion prediction feature, the target image feature, and the second image feature.

19. The electronic device according to claim 18, wherein, the determining the second loss function according to the fusion prediction feature, the target image feature, and the second image feature, comprises:
acquiring a first similarity between the fusion prediction feature and the target image feature;
acquiring a second similarity between the fusion prediction feature and the second image feature; and
determining the second loss function according to the first similarity and the second similarity.

20. The electronic device according to claim 17, wherein, the updating the model parameter of the first model, according to the first loss function and the second loss function, comprises:
acquiring a first weight corresponding to the first loss function and a second weight corresponding to the second loss function; and
updating the model parameter of the first model according to the first loss function, the first weight, the second loss function and the second weight.

21. The electronic device according to claim 11, wherein, the determining a fusion prediction feature of the first image block and the second image block, according to the first image feature, comprises:
acquiring a first vector;
fusing the first vector and the first image feature, to obtain a fusion vector; and
obtaining the fusion prediction feature according to the fusion vector.

22. The electronic device according to claim 11, wherein, the acquiring a target image feature in a target image, comprises:
determining a first region in the target image, according to a position of the second image block in the first sample image;
performing offset processing on the first region, to obtain a second region; and
determining an image feature corresponding to an image block within the second region in the target image as the target image feature.

23. The non-transient computer readable storage medium according to claim 12, wherein, the updating a model parameter of the first model, according to the first image, the second image block, the fusion prediction feature and the target image feature, comprises:
determining a first loss function of the first model, according to the first image and the second image block;
determining a second loss function of the first model, according to the fusion prediction feature and the target image feature; and
updating the model parameter of the first model, according to the first loss function and the second loss function.

24. The non-transient computer readable storage medium according to claim 23, wherein, the determining a second loss function of the first model, according to the fusion prediction feature and the target image feature, comprises:
acquiring a second sample image, and determining a second image feature of the second sample image, wherein the second sample image is an image other than the first sample image; and
determining the second loss function according to the fusion prediction feature, the target image feature, and the second image feature.
